(19) United States
(12) Patent Application Publication
(10) Pub. No.: US 2005/0154976 A1
(43) Pub. Date: Jul. 14, 2005

(54) Method and system for automated metamodel system software code standardization

(76) Inventor: Brent Dalmas Nelson, Plano, TX (US)

Correspondence Address: DOCKET CLERK, DM/EDS, P.O. DRAWER 800889, DALLAS, TX, 75380, US

(21) Appl. No.: 10/675,059

(22) Filed: Sep. 30, 2003

(51) Int. Cl. G06F 17/00

(52) U.S. Cl. 715/513; 715/511; 705/500

(57) ABSTRACT

A method and system automatically converts (140) standards-noncompliant metamodel systems into standards-compliant metamodel systems. The invention begins by substituting automatically (152,174) standards-noncompliant hyperlinks in first metamodel system with standards-compliant hyperlinks. Substituting automatically (156,158) standards-noncompliant entity names associated with entities standards-compliant entity names occurs in the process. Then, the invention substitutes automatically (156,158) standards-noncompliant file names for associated files with standards-compliant file names for the associated files. Organizing (160) entities having standards-compliant entity names into files having standards-compliant file names further occurs. The invention converts (164) object identity values associated with objects into a single predetermined object identity value. Then, the invention substitutes standards-noncompliant relationship types with standards-compliant relationships types (168) and remaining standards-compliant mark-up language with standards-compliant mark-up language (170) to yield the standards-compliant metamodel system (172,174).

### BACKGROUND OF THE INVENTION

Computers are known as effective tools for modeling many types of physical phenomena and organizations, such as a business enterprise. One type of modeling tool is an object-oriented modeling system, which establishes a computer-based environment for replicating an actual environment or interactive set of systems. Object-oriented modeling environments include sets of object types, type views, relationship types, primitive types, methods, criteria (queries), symbols, and may be implemented in a computer mark-up language, such as XML. The set of object types, type views, relationship types, etc. available for use in a model is known as a metamodel. Metamodels are developed in metamodeling environments or systems, and are designed for particular modeling purposes, such as enterprise architecture, process modeling, or knowledge modeling, among others.

Enterprise architecture modeling includes, for example, modeling human capital allocations and fixed assets. Both governmental entities and commercial industries are expanding their use of modeling so much that there has been the emergence of the “business technologist” position in many enterprises as a technically qualified analyst responsible for enterprise modeling. The expansion of modeling into all aspects of business such as the monitoring of project deployments; tracking supplier purchases by congressional region; process improvement exercises; tracking Federal regulations; and coordinating parts documentation is ever increasing.

A key part of modeling an enterprise is to establish and work within an enterprise architecture model. An enterprise architecture model enables the illustration and depiction of enterprises and their ongoing processes, their customers and their suppliers. Wherever there are models there will be a need for metamodels and metamodel development to maintain and extend the. A metamodel for an enterprise architecture model provides the object types, relationship types, etc., that will be used to construct the models. Each model will consist of a set of instances, i.e., objects created using the object types, relationships created using the relationship types, etc., as defined in the metamodel. A model constructed using a well-designed metamodel will accurately record the entities and relationships in the enterprise it was built to represent, and how they interact with one another. A metamodeling environment, therefore, enables model builders to build models. The models offer both a visual representation and a data representations, which help end users develop an improved understanding of the enterprise architecture. This improved understanding helps decision makers and architects, who use the results of these models, and who put these enterprise models to work, to share a common understanding of the enterprise.

In modifying or revising an existing metamodel or creating a new metamodel, it has been found difficult to modify the metamodel in an expeditious way. Metamodels may include numerous object types, relationship types, methods, and symbols in a model. Many early metamodels have focused almost exclusively on system functionality and graphical representation, even to the exclusion of the model's subsequent programmability.

Over time, however, modeling and metamodeling efforts have developed naming standards, physical design standards, and other intellectual capital to guide their on-going development. These standards permit increasing complexity of data and processes, while at the same time avoiding the complications of having different formats or different data fields to achieve the same type of functionality. This is particularly true when it becomes necessary to make changes to the metamodel system software.

By using standards, it is possible to identify more readily where in a particular program a change needs to be made, as well as the type of change that the standardized system will permit. Without standards relating to the structure and the names of particular items and processes within a computer program, making the changes requires a measure of reverse engineering of the subject software. This can be extremely time-consuming and may generate numerous potential errors in the resulting changed software.

These standards, however, can cause the production of metamodels that are significantly different from those in the earlier proof-of-concept metamodels. Unfortunately, due these material differences, proof-of-concept and other earlier metamodel systems cannot be used where standard-compliant metamodel systems are required. This is because the earlier metamodel systems fail to employ the later-developed standard names, designs, and other features. This lack of later utility exists even when there may be a very close match to the logic and associated problem solution of the standard-noncompliant metamodel system.

To make these standards-noncompliant metamodel systems useable requires a conversion effort that preserves the existing logical metamodel, while drastically changing the underlying physical metamodel. The logical metamodel is the aspect of the metamodel that is seen by end-users. In the logical metamodel, entities can be recognized by their easily understandable names, descriptions, symbols, and behaviors. The physical metamodel, on the other hand, consists of the files and their structures, the folders, the physical names of entities not seen by end users, the object identifier numbers, the property names and data types, the hyperlinks that connect all of these entities together physically. For example, metamodel systems developed using the Metis® metamodeling system consist of inter-related XML files that specify the object types, relationship types, primitive types, symbols, typeviews, methods, criteria (queries), etc. that a model developer may use to build a functional model.

Because of the programming complexities in changing standards-noncompliant files, such as the Metis® inter-related XML files, to standards-compliant files, metamodel developers typically will not use the standards-noncompliant metamodel. Instead, developers simply start over and re-implement the logical design of a metamodel system using the new standards. In many instances, however, particularly when a standards-noncompliant metamodel may possess many valuable logical relationships and structure that would be difficult to replicate, starting anew can be a less than optimal approach.

Accordingly, there is a need for a method and system for preventing the loss of developer hours and logical structures and functions that occurs when a standards-noncompliant metamodel cannot be used for subsequent metamodel development and modification in a standards-compliant programming environment.

A need exists for a method and system that avoids the many hours of manual modification required to transform a standards-noncompliant metamodel system into a standards-compliant metamodel system.

A further need exists for a metamodel system transformation method and system that provides a fast and economical way to convert a standards-noncompliant metamodel system to a standards-compliant metamodel system, while preserving all inter-relationships, irrespective of the metamodel system's complexity.

### SUMMARY OF THE INVENTION

In accordance with the present invention, therefore, there is here provided a method and system for automated metamodel system software code standardization that substantially eliminates or reduces the disadvantages and problems associated with prior methods and systems for transforming standards-noncompliant metamodel systems into standards-compliant metamodel systems.

According to one aspect of the present invention, there is provided a method and system for automatically converting standards-noncompliant metamodel systems into standards-compliant metamodel systems. The invention substitutes automatically standards-noncompliant hyperlinks in the first metamodel system with standards-compliant hyperlinks. Substituting automatically standards-noncompliant entity names associated with entities standards-compliant entity names also occurs. The invention further substitutes automatically standards-noncompliant file names for associated files with standards-compliant file names for said associated files. Organizing entities having standards-compliant entity names into files having standards-compliant file names occurs within the process of the invention. The invention converts object identity values associated with objects into a single predetermined object identity value. Moreover, substituting standards-noncompliant relationship types with standards-compliant relationships types and remaining standards-compliant mark-up language with standards-compliant mark-up language yields the standards-compliant metamodel system.

Technical advantages of the present invention include significantly reduced errors in the development of metamodel system input for generating new metamodel systems. The present invention, compares, sorts, and analyzes metamodel files and entities more easily and rapidly than can prior manual approaches and tools, and then directly translates specifications into executable metamodel files. Using a series of steps implemented in Microsoft® Visual Basic Script®, Excel®, and Visual Basic® for Applications® (VBA®⁾ for the preferred embodiment, the present invention produces a completely restructured or “standards-compliant” metamodel that complies with standards governing metamodel system development.

Another technical advantage is that the present invention is a repeatable and documented metamodel conversion process that takes a standards-noncompliant metamodel system as input and produces a standards-compliant metamodel that leverages the intellectual capital embodied in the original standards-noncompliant metamodel. The present invention, therefore, leverages the intellectual capital in proof-of-concept or earlier metamodel systems. The present invention also provides a process and associated development tools for the conversion of existing standards-noncompliant metamodel systems to generate new metamodel systems. Using these tools, converting existing models is much faster and less resource-intensive than re-building them from scratch as wholly new metamodels. Furthermore, older metamodels that need to be standardized can be made useable through the intelligent application of the present invention. This will result in significant cost and time savings in metamodel system development.

Other technical advantages are readily apparent to one skilled in the art from the following FIGUREs, description, and claims.

### BRIEF DESCRIPTION OF THE DRAWINGS

For a more complete understanding of the present invention and advantages thereof, reference is now made to the following description which is to be taken in conjunction with the accompanying drawings and in which like reference numbers indicate like features and further wherein:

FIG. 1 illustrates a computing system that may employ the teachings of the present invention;

FIGS. 2a and 2b show a metamodel system which may employ the teachings of the present invention;

FIG. 3 presents an example of an enterprise architecture framework that may be useful for instituting a standardized nomenclature for the entity and file structures employed in the present invention;

FIG. 4 depicts a flow chart for transforming a standards-noncompliant metamodel system to a standards-compliant metamodel system according to the teachings of the present invention; and

FIG. 5 illustrates one example process 180 of transforming a standards non-compliant metamodel 182 into a standards compliant metamodel 184 according to the teachings of the present invention.

### DETAILED DESCRIPTION OF PREFERRED EMBODIMENT

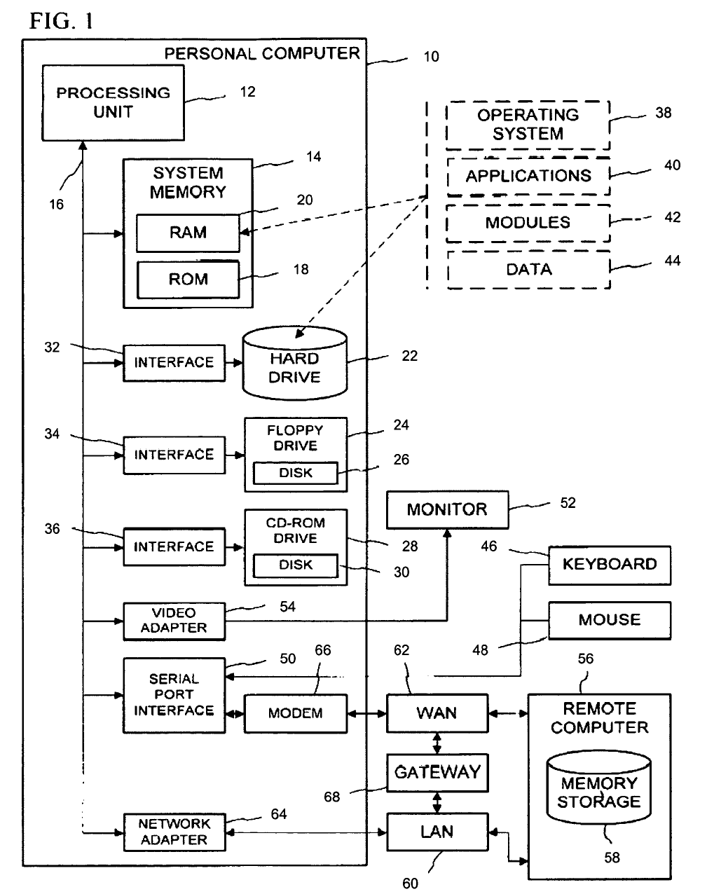

The preferred embodiment of the present invention and its advantages are best understood by referring to FIGS. 1 through 4 of the drawings, like numerals being used for like and corresponding parts of the various drawings, and Table 1, herein.

FIG. 1 illustrates a general-purpose computer 10 that may use the method and system for transforming standards-noncompliant metamodel files to standards-compliant metamodel files. General purpose computer 10 may be used as a stand-alone computer or as part of a larger, networked system of personal computers. Using at least two such computers, for example, the present invention makes possible the transformation of a standards-noncompliant metamodel system to a standards-compliant metamodel system at different locations within a given enterprise. Here, FIG. 1 facilitates an understanding of how one might use the system of the present invention. General-purpose computer 10 may be used to execute distributed applications and/or distributed and individually operating system services through an operating system.

With reference to FIG. 1, an exemplary system for implementing the invention includes a conventional computer 10 (such as personal computers, laptops, palmtops, set tops, servers, mainframes, and other variety computers), including a processing unit 12, system memory 14, and system bus 16 that couples various system components including system memory 14 to the processing unit 12. Processing unit 12 may be any of various commercially available processors, including Intel x86, Pentium and compatible microprocessors from Intel and others, including Cyrix, AMD and Nexgen; Alpha from Digital; MIPS from MIPS Technology, NEC, IDT, Siemens, and others; and the PowerPC from IBM and Motorola. Dual microprocessors and other multi-processor architectures also can be used as the processing unit 12.

System bus 16 may be any of several types of bus structure including a memory bus or memory controller, a peripheral bus, and a local bus using any of a variety of conventional bus architectures such as PCI, VESA, AGP, Microchannel, ISA and EISA, to name a few. System memory 14 includes read only memory (ROM) 18 and random access memory (RAM) 20. A basic input/output system (BIOS), containing the basic routines that help to transfer information between elements within the computer 10, such as during start-up, is stored in ROM 18.

Computer 10 further includes a hard disk drive 22, a floppy drive 24, e.g., to read from or write to a removable disk 26, and CD-ROM drive 28, e.g., for reading a CD-ROM disk 30 or to read from or write to other optical media. The hard disk drive 22, floppy drive 24, and CD-ROM drive 28 are connected to the system bus 16 by a hard disk drive interface 32, a floppy drive interface 34, and an optical drive interface 36, respectively. The drives and their associated computer-readable media provide nonvolatile storage of data, data structures, computer-executable instructions, etc. for computer 10. Although the description of computer-readable media provided above refers to a hard disk, a removable floppy and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 20, including an operating system 38, one or more application programs 40, other program modules 42, and program data 44. A user may enter commands and information into the computer 10 through a keyboard 46 and pointing device, such as mouse 48. Other input devices (not shown) may include a microphone, joystick, game pad, satellite dish, scanner, or the like. These and other input devices are often connected to the processing unit 12 through a serial port interface 50 that is coupled to the system bus, but may be connected by other interfaces, such as a parallel port, game port or a universal serial bus (USB). A monitor 52 or other type of display device is also connected to the system bus 16 via an interface, such as a video adapter 54. In addition to the monitor, computers typically include other peripheral output devices (not shown), such as speakers and printers.

Computer 10 may operate in a networked environment using logical connections to one or more remote computers, such as a remote computer 56. Remote computer 56 may be a server, a router, a peer device or other common network node, and typically includes many or all of the elements described relative to the computer 10, although only a memory storage device 58 has been illustrated in FIG. 1. The logical connections depicted in FIG. 1 include a local area network (LAN) 60 and a wide area network (WAN) 62. Such networking environments are commonplace in offices, enterprise-wide computer networks, intranets and the Internet.

When used in a LAN networking environment, the computer 10 is connected to the LAN 60 through a network interface or adapter 64. When used in a WAN networking environment, computer 10 typically includes a modem 66 or other means for establishing communications (e.g., via the LAN 60 and a gateway or proxy server) over the wide area network 62, such as the Internet. Modem 66, which may be internal or external, is connected to the system bus 16 via the serial port interface 50. In a networked environment, program modules depicted relative to the computer 10, or portions thereof, may be stored in the remote memory storage device 58.

It will be appreciated that the network connections shown are exemplary and other means of establishing a communications link between the computers may be used. FIG. 1 only provides one example of a computer that may be used with the invention. The invention may be used in computers other than general-purpose computers, as well as on general-purpose computers without conventional operating systems.

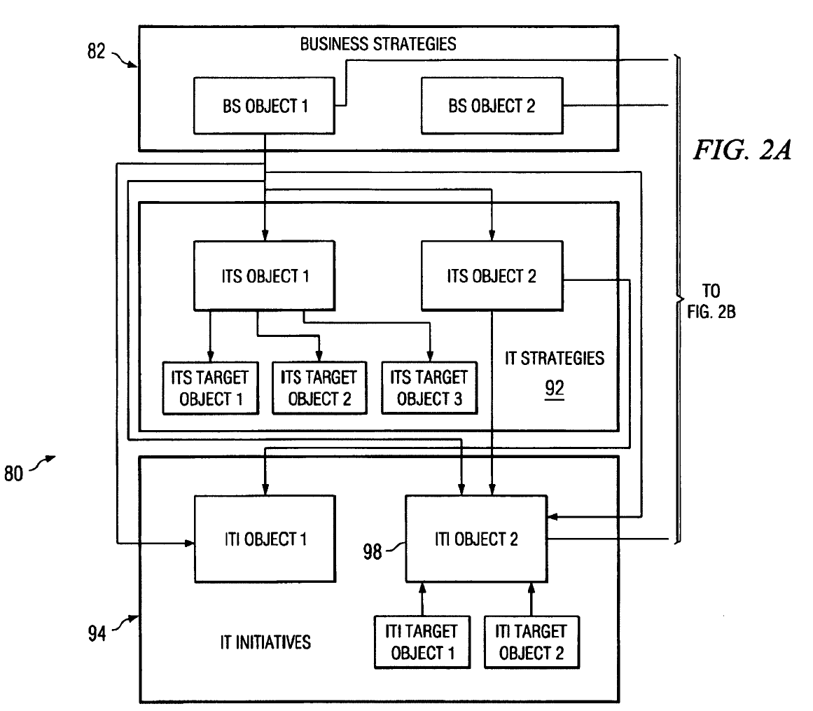

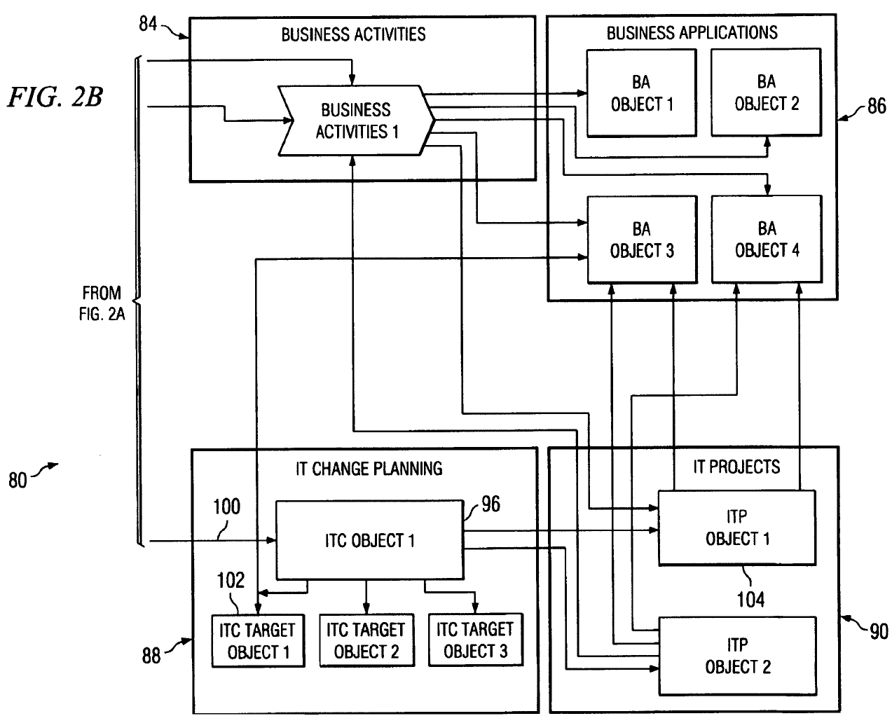

FIGS. 2a and 2b graphically show metamodel system 80 for which the present invention provides a method and system for transforming a standards-noncompliant metamodel system into a standards-compliant metamodel system. Although metamodel 80 illustrates a specific example of a metamodel, it also usefully depicts general relationships and objects appearing in the various components of an enterprise metamodel. These, for instance, may include Business Strategies component 82, Business Activities component 84, Business Applications component 86, IT Change Planning component 88, IT Projects component 90, IT Strategies component 92, and IT Initiatives component 94.

Within each component, such as IT Change Planning component 88 appear visualizations of objects, such as IT change or ITC object 96. ITC object 96 associates with ITI object 98, as relationship object or connector 100 depicts. ITC object 96 may also associate with certain IT change planning sub-objects such as ITC target object 102 for different functions, such as in this instance, IT change planning. Outputs from ITC object 96 may further pass to ITD object 104 within IT projects component 90. Thus, with metamodel 80, the user may create a visualization of a functional metamodel of an enterprise.

The following provides some basic nomenclature for better understanding the context and application of the present invention. A model is a useful representation of some subject. It is an abstraction of a reality expressed in terms of some language defined by modeling constructs for the purpose of the user. Models have semantic interpretations that are consistent and inherently understood. A metamodel is a definition or collection of definitions for using objects and relationships in a model. Specifically, a metamodel defines object types, relationship types, methods that can be performed on particular object types, as well as criteria that can be used to search a model. Metamodel information related to a particular area of knowledge is grouped into domains. Every template and model includes references to specific domains to designate which object types, relationship types, methods, and search criteria can be used in a model.

An enterprise model is a method to help determine the total impact of a requested initiative on an enterprise. It provides the structure and repeatable processes to obtain facts and data for an organization leadership to make informed decisions that support its vision. The enterprise model may include of components such as enterprise operations framework; an investment strategy; an integration roadmap and governance. The enterprise model models an enterprise system, which is any integrated solution for linking business processes, data and applications across functions, geographies and business units within an enterprise. The enterprise operations framework provides a complete systems view of how an organization operates today and in the future to achieve its vision of becoming the global leader in the digital economy. It is the foundation for the overall systems design and operation, and represents how an organization will operate, verifies the systems current operational state, and indicates where and how current initiatives are changing the systems base. The enterprises operation framework provides the structure and repeatable methods to employ other components of the enterprise model, such as the investment strategy, the integration roadmap or the governance.

A useful metamodel system provides a visual modeling tool allowing a user to understand increasingly complex enterprises. This enables decision makers and those that carry out the everyday work to share a common understanding, all represented as a visual model. The model forms the basis for making informed decisions, since it becomes possible to reveal the complex interplay within the enterprise.

A metamodel system is designed to accommodate the diverse needs in large corporations. The structure of the metamodel system includes a system editor module, which allows the user to build and maintain models. The system designer module includes additional features for setting up and defining model structures. It also comes with a symbol editor, allowing changes in the visual appearance of model elements. The metamodel developer makes possible customizing metamodels, and developing support for new standards and frameworks.

When publishing models on an Intranet (or on the Internet), a metamodel browser may give the user the full visual power of metamodel in read-only mode. The metamodel may also include a system annotator which can be regarded as a browser with the added capability of creating annotations or comments on objects in existing models. These annotations become visible to the owner of the model, who may then review them. Common features for the different system modules include the properties of them all being stored as XML-files with designer/editor functions scriptable over COM-interface. Graphics for such a model are SVG (Scalable Vector Graphics) and the module designer may include a built-in editor and import function. Custom criteria (queries) in such a system may be easily pre-defined and run from action-buttons.

A metamodel system is a collection of object types, relationship types, methods, and search criteria related to a particular area of knowledge. For example, a metamodel may include templates for an organization and its resources as they may be used in the operation of an enterprise. Whereas, a model includes groups of related objects and relationships that represent information about an enterprise. Models permit analyzing complex systems, to help answer business questions, and to solve business problems and consists of one or more model views that are used to organize and display information in a meaningful way.

A view includes a graphical representation of objects and relationships in a model. A metamodel system may provide, for example, three types of views, such as model view, object view, and relationship view. The object and relationship views are shown in model views. The label property is the name of any property for an object or relationship type that can be displayed on a tool tip and is usually displayed on the symbol. The property label for each type is defined in the metamodel. The value of this property is displayed on the object's symbol and can also be displayed on a tool tip.

A metamodel data file can contain model data, for example, objects and relationships. A metamodeling system may receive new files and relocate objects between model data files. In a metamodel system, a type label is the name of the object or relationship type that is displayed for the user, for example, Organization. A component of a model is an object, which represents a specific piece of information about an enterprise (for example, a process, sub-process, process input, process output, or document). An object is created from an object type and values are set for the properties defined in that type. An object is referenced through its Uniform Resource Identifier (URI). Objects are graphically represented on the screen through object views.

The object type characterizes a specific type of information that may be modeled. For example, a metamodel may define the object type Organization, which can be used to represent the parts of an organizational structure within an enterprise. The object type characterizes the properties that an object can have, such as name and description or the default symbol used to represent the object on screen. A model tree could list all the object types available for use in the current model. The object view can provide the visual representation of an object on the screen, by defining the symbol, location, and zoom level used to display the object.

Evolving generations of metamodels for different enterprise applications models may use very similar logical formulations and relationships to those established for previous generations of metamodels. As mentioned, however, these earlier metamodels may not conform to current standards for naming, organization, and structure. While this may pose an overwhelming problem for metamodel developers, the present invention provides a way to employ an earlier established metamodel in a subsequent application of a standards-compliant environment with a standards-compliant model.

These standards concern, for example, the relationships between the logical model of the metamodel system and the physical model which the logical model emulates. This includes the way that the user would see the different logical components within the system connecting and the relationships that exist in the logical metamodel and the actual physical model.

In a metamodel system, it is not practical to have one section of the metamodel well-structured, according to a set of standards, while other parts of the system are poorly structured, without the poorly modeled parts affecting the well-structured parts. As a result, without programming and model formation standards, knowledge management, reuse, and other benefits from the software become challenging. Table 1 shows a comparison between an exemplary standards-noncompliant metamodel and a standards-compliant metamodel in terms of physical characteristics.

TABLE 1

| Physical | | |
|---|---|---|
| Metamodel | Standards-Noncompliant | Standards Compliant |
| Feature | Metamodel | Metamodel |
| Overall | Loosely organized | Strictly organized |
| organization | according to subject area, | according to entity |
| | in a few large files | type, in many small |
| | | files |
| Number of | Many entities per file | One entity per file, |
| entities per file | | with one qualified |
| | | exception |
| Object identifiers | Integers in the range 1 to n | All have the value 1 |
| File names | Files named according to | File names are |
| | subject area and/or entity | systematic |
| | types | transformations of |
| | | entity logical names |
| Entity type names | No particular standards; | Naming standards |
| | loose relationship between | applied to all entity |
| | logical and physical names | types consistently |
| Folder | Some segregation by entity | Each entity type is |
| organization | type, but not | found in one and only |
| | consistently, because | one folder |
| | files may contain multiple | |
| | entity types | |
| Relationship | Multiple origin object | Only one origin object |
| types | types and multiple target | type permitted; |
| | types permissible; named | multiple target object |
| | after their verb; verbs | types permitted; named |
| | may be assertive or | after <origin> <verb> |
| | passive | <target>; |
| | | all verbs assertive in |
| | | left-to-right |
| | | orientation |
| Hyperlinks | Local, relative, folder- | All folder-based |
| | based relative, and | relative |
| | absolute | |

As Table 1 depicts, the overall organization of a standards-noncompliant metamodel may be loosely or only slightly organized, wherein a few large files are roughly grouped into different subject areas. Thus, there may be a small number of large files containing numerous XML-language entities for different components within the system. For example, there may be a file containing the technical architecture of the metamodel system, which relates to the networks and technical infrastructure of an organization. In the technical architecture file, there may object types and relationship types, as well as methods and criteria that relate to the technical architecture of an enterprise. There may be other files, such as enterprise architecture files, which include such items as the organization, the business objectives, and other soft or non-technical aspects of the enterprise.

Referring to Table 1, a standards-noncompliant metamodel may be physically structured in a domain-oriented way. In this physical structure, all metamodel entities relating to a particular subject area may be physically together in large multi-entity files. Within these files, all entities may be assigned object identifiers that were unique within the file. All of these entities may then be cross-referenced within the standards-noncompliant metamodel files using a variety of hyperlinks based on the file names and object identifiers. Such a formation may work well for the purpose of demonstrating the use of a metamodel to support enterprise architecture modeling. However, as metamodeling efforts mature and develop standards for physical structures that are suitable for multiple projects, sub-modeling, and other more complex uses, this unstructured and confused physical metamodel structure will no longer be suitable to leverage the original intellectual capital from the metamodel.

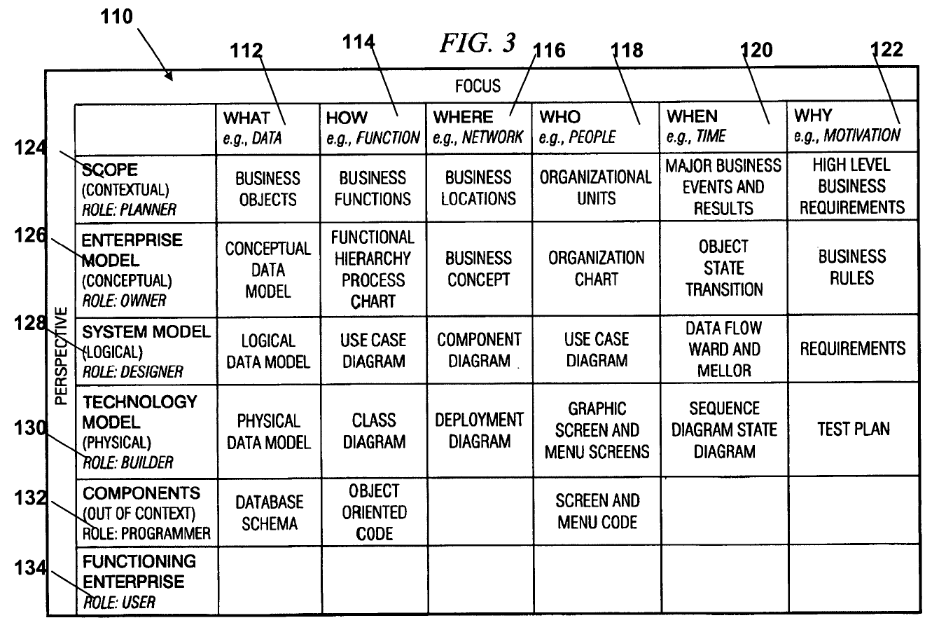

In the standards-noncompliant metamodel, entity type names may take on any form. Whereas, in the standards-compliant metamodel, the entity type names may be assigned in a uniform or logical way according to an established, and preferably universal, paradigm or framework. One such standard for the logical framework of an enterprise architecture would be the Zachman Framework provided by the Zachman Institute For Framework Architecture. FIG. 3 provides Zachman framework matrix 110. Such a framework may aid in establishing an enterprise architecture structure and function for a metamodel system. In framework 110, columns relate to functions, while rows relate to the different structural roles that exist in a particular enterprise. Thus, What column 112 relates to data, How column 114 relates to functions within the enterprise, Where column 116 relates to network locations, Who column 118 relates to people within the enterprise, When column 120 relates to time for different functions, and Why column 122 relates to motivation within the enterprise.

At the various enterprise levels, Scope row 124 relates to the planner role, Enterprise Model row 126 relates to the owner role, System Model row 128 relates to the designer role, Technology Model row 130 relates to the builder role, Components row 132 relates to the programmer role, and Functioning Enterprise row 134 relates to the enterprise architecture model user. Within the cells at the intersection of functions columns 112 through 122 with enterprise role rows 124 to 134 are potential standards-compliant entity names. Thus, using a standard format and the standard terminology of framework matrix 110, the ability to form a standards-compliant enterprise architecture standardized entity names results. In a standards-compliant metamodel, moreover, each entity may be in separate files which are strictly organized according to entity type.

Another aspect of a non-standard system would be that it would include many entities in a particular file. The standards-compliant system may use one entity per file, except, for example, the instance of a “metamodel file” within the metamodel itself. These metamodel entities provide a navigation tree that allows the user to navigate from one point to another within the particular metamodel. This would also benefit the effort to change a particular file or a particular object. This would permit, for example, switching out an object through looking at an object type file. This would identify the object type and permit the ready substitution of the particular object file.

Another difference between a standards-noncompliant metamodel file and a standards-compliant metamodel file appears in the use of object identifiers. In a standards-noncompliant system, integers identify particular objects and may range from one to n, where n is the number of objects. On the other hand, in a standards-compliant metamodel formed according to the present invention, all of the object identifiers would have the value 1, because each occurs in a separate file.

Another characteristic of a standards-noncompliant metamodel is that the file names are named according the subject area or entity types. With a standards-compliant metamodel formed according to the teachings of the present invention, file names are systematic transformations of associated entity logical names. For example, the “Application” file in the standards-compliant metamodel would be named “applications.kmd.” As a result of this convention, the present invention makes possible immediately identifying a the particular file implementing a particular object type within a metamodel system.

Moreover, in a standards-noncompliant metamodel system, the entity type names may have a loose relationship between the underlying logical and physical models. With the standardized system of the present invention, naming standards are applied to entity types in a consistent way. The present invention applies both the physical name and logical names in the same way. Thus, for example, if the logical name of an entity is “Application,” the physical name will also be “application.”

Also, for a standards-noncompliant metamodel, folders may be organized inconsistently according to the various entity types. This would be because files may contain multiple entity types. If there was the desire to obtain a particular relationship type, there would be the need to search all of the files in the entire metamodel for the one containing that specific relationship type. In the standards-compliant metamodel system formed through use of the present invention, each entity type is found in one and only one folder. With this type of organization, all relationship types, for example, appear in a relationship type folder.

Relationship types are also specified differently between standards-compliant and standards-noncompliant metamodels. In a standards non-compliant system, multiple origin object types may relate to multiple target types using a single relationship type. In such a standards non-compliant system, it is difficult to determine which relationship types may be used to connect to a particular object type. Also, the relationship names, which generally are verbs, attempt to indicate directionality. The active voice denotes that a relationship flows from an origin object to a target object. The passive voice denotes an opposite directionality. In a standards-noncompliant system, active and passive voice verbs may be intersperse with one another. In such a situation, redundant relationship types may occur due to the different words associated with the different voice verbs. This makes it difficult for metamodelers to know which relationship types may be redundant or conflicting, and for modelers to understand the resulting model.

In the standards-compliant metamodel formed according to the present invention, one origin object type is permitted, while it is possible to have multiple target types. The construction of the relationship between an origin object and a target object would have the form <origin><verb><target>. Here, only one origin object type is permitted, with the actual name of the relationship becoming <origin><verb><target>, which relationship has an associated file with this precise name. In the case of multiple target types, the file name becomes <origin><verb><“(various target types)”>. This latter construction makes possible knowing that there are two or more target object types relating to the origin and specific relationship. Moreover, in the standards-compliant metamodel, all verbs denoting relationship are asserted from an origin object to a target object. Accordingly, all relationships appear in the active voice, e.g., “Application implements Logical Application”, not “Logical Application is implemented by Application”

The standardization of hyperlinks addresses the problem of standards-noncompliant systems provide numerous types of hyperlink formats, such as local formats, relative formats, folder-based relative formats, and absolute hyperlink formats. This, in effect, results in at least five different forms of hyperlinks, which, because of their differences, may significantly limit their utility. One problem with inconsistencies in the different types of hyperlinks formats is that if a particular hyperlink file moves from its original location within the metamodel system, the hyperlink oftentimes no longer works. To overcome this limitation, the present invention forms a standards-compliant metamodel wherein all hyperlinks are folder-based relative hyperlinks.

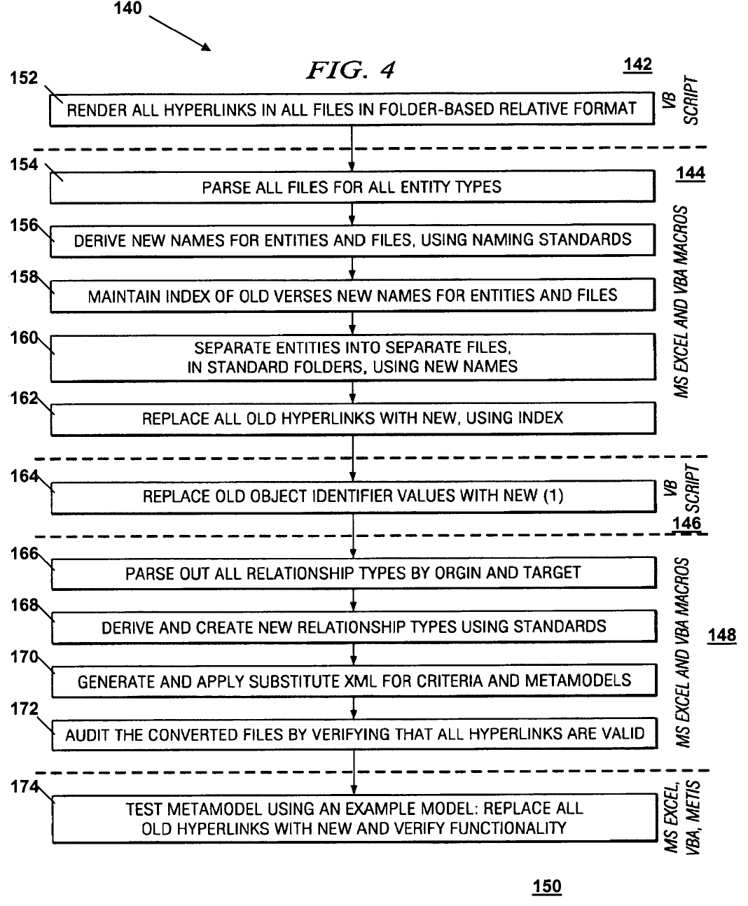

FIG. 4 provides conversion flowchart 140 for explaining the progressive steps of the present invention in converting a standards-noncompliant metamodel system to a standards-compliant metamodel system. The preferred embodiment provides a set of Visual Basic Script® and Excel® spreadsheet macros and Visual Basic Application® macros for performing the specified conversion in a well-defined sequence of steps. Although the preferred embodiment is specific to the Metis® programming environment, there may be broader application of the present invention in the context as a generalized process for standardizing the metamodeling environment. Thus, the logic of the present invention may be applied to a large number of metamodel language files or metamodeling systems for converting standards-noncompliant systems to standards-compliant systems.

Note that conversion flowchart 140 of FIG. 4 includes partitions of including VB Script® region 142, Microsoft® Excel® and VB Macros® region 144, VB Script® region 146, Microsoft® Excel® and VBA Macros® regions 148 and Microsoft Excel®^{,} VBA®^{,} & Metis® region 150. The generalized characterization of applications and languages that might be used for the processes of FIG. 4 may include, for example, where the VB Script® regions are identified, a Java Script® or similar scripting language other than VB Script® could be used. Also Microsoft® Excel® and VBA Macros® indicate the use of the Microsoft® software environment. However, other than Microsoft® software is contemplated to be within the scope of the present invention. Moreover, although the specific embodiment of the present invention applies to a Metis® modeling environment, an environment that uses extended markup language or similar language for metamodel and model formation and use may employ the process of the present invention.

In FIG. 4, beginning at step 152 of conversion flowchart 140 the process of the present embodiment takes all hyperlinks in the program and renders them in a folder-based relative form to achieve a standardized hyperlinks form. This causes the creation of hyperlinks in the form “ . . . \<folder name>\<file name>.kmd#oid1”. This form that will be used for all hyperlinks in the resulting standards-compliant metamodel system and has the result of making the hyperlinks portable. The present embodiment achieves this through the use of a series of VB Script® applications that identify all hyperlinks and convert the hyperlinks to the folder-based relative form. For the many types of hyperlink forms that a standards-noncompliant metamodel system may exhibit, there will be associated sets of instructions to transform such hyperlink formats into the folder-based relative format.

Step 154 relates to the step of parsing all files from all entity types. This involves the use of VBA Macros® for opening all files in standards-noncompliant metamodel to identify and build an index from the entity types existing in the metamodel. The resulting index shows all of the entities or which files contain these specific entities. This step would also include identifying the URI (Universal Resource Identifier) to extract from the particular files the important characteristics associated with the entity types.

Step 156 of the conversion flowchart 140 involves deriving new names for entities and files using a predetermined set of naming standards. This results in a number of spreadsheets that would serve as an index of the different entity types. From these spreadsheets, which would be formed in Microsoft® Excel® in the preferred embodiment, new names compliant to the standard format will be assigned to each entity.

For example, the process may look at the “Logical Application” entity. The present invention may, for instance, find the “Logical Application” entity to be in a file called “apps”. Step 154 of conversion flowchart 140 involves, therefore, converting the file named “apps” to the name “logicalApplication.kmd.” Based on this approach, the present invention provides an automated way to determine what the particular new file name should be based on the contents of the associated spreadsheet. At step 158, conversion flowchart depicts the maintenance of an index denoting the translation between the old “apps” name and the new “logicalApplication.kmd.”

Step 160 presents the step of separating entities into separate files, in standard folders using the new names. In this step 160, for example, if a “methods” file appears in an objects folder, the present invention moves the “methods” file to the “methods” or equivalent folder. This translation and movement of files into the respective folders is also indexed in associated spreadsheets at step 160.

As a result of the automated separation process of step 160, instead of having a number of files with standards-noncompliant names and standards-noncompliant entities, there result separate standards-compliant files with standards-compliant names associated with respective standards-compliant entities and stored in standards-compliant folders.

At step 162, the hyperlinks that were rendered in folder-based relative form in step 152 are replaced with new hyperlinks using the index that has been derived up to this point in the process of conversion flowchart 140. From this point forward, the process of conversion flowchart 140 will use the derived index in the automated translation.

Step 164 relates to replacing old object identifier or “oid” values with a new value, generally the value 1. Thus, for example, in the instance of the ‘apps’ file, the oid may be “oid17.” At step 164, this value of “oid17” is converted to “oid1”, after the file name has been converted to “logicalApplication.kmd.” Step 164 completes the standardization of files, names of entities, and oid numbers.

The present invention further addresses, beginning at step 166, the relationship types that exist between origin objects and target objects. Thus, step 166 involves parsing out all relationship types in the respective files according to the origin object and target objects to which the relationship types pertain. At step 168, the present invention further derives and creates new relationship types using a standardized process. This may involve, for example, automatically identifying the origin and target object types for a particular relationship type. Then, the conversion process makes possible a manual step to determine whether the relationship type verb is in active or passive voice. However, this step could be automated. In the event that the relationship is a passive verb, the new standards-compliant relationship type may need to be defined in the opposite direction. E.g., if the standards non-compliant metamodel contained a relationship type “Logical Application is implemented by Application”, the standards would require reversing this relationship type definition to read “Application implements Logical Application”.

Accordingly, the process at step 168 reverses the relationship type direction by interchanging the origin and target object types and using a verb in active voice. Thus, in one embodiment, the present invention, at step 168, may further involve the step of identifying which relationship types need to be reversed and then actually reversing these relationship types. As a result of step 168, the specifications for the new relationship types exist. From the actions occurring at step 168, the relationship type files may now be created according to the contents of associated spreadsheets and VBA Macros® that employ and document, and further index the relationships types. The specifications for the new relationship types permits the creation of new relationship files. Here, also, the process uses the derived indices for creating the new relationship types.

Step 170 of conversion flowchart 140 uses Microsoft® Excel® and VBA Macros® for the purpose of generating and applying substitute XML script for the criteria and the associated metamodels. Criteria may be considered as queries or specified tests within a given metamodel. For example, a criteria would enable command of directing the metamodel to show the user all Applications that would implement a given or a particular Logical Application.

Steps 172 and 174 relate to the portion of conversion flowchart 140 wherein the previous steps are audited (step 172) and tested (step 174) to verify that the new standards-compliant metamodel system can achieve the logical functionality of the standards-noncompliant metamodel system. Moreover in step 174, conversion flowchart 140 replaces any remaining standards-noncompliant hyperlinks with new hyperlinks that proved to be non-functional or otherwise inappropriate. This auditing verifies that there is the appropriate connection between the hyperlink and the intended model system file.

At step 174, the process involves testing the metamodel using an example model. The process would be run on the associated model to verify that the hyperlinks do in fact connect between the metamodel and the underlying model. This would involve opening the model to verify that all of the components work properly relative to the model itself and to the associated metamodel. By verifying that both the metamodel and the model work, the process yields the associated standardized metamodeling in association with the underlying model. This completes the process of conversion flowchart 140. Thus, by using the process of the present invention, it is possible to take a standards-noncompliant, unorganized metamodel system and generate a standards-compliant, organized, universally usable, metamodel system that may be associated with a number of standardized models.

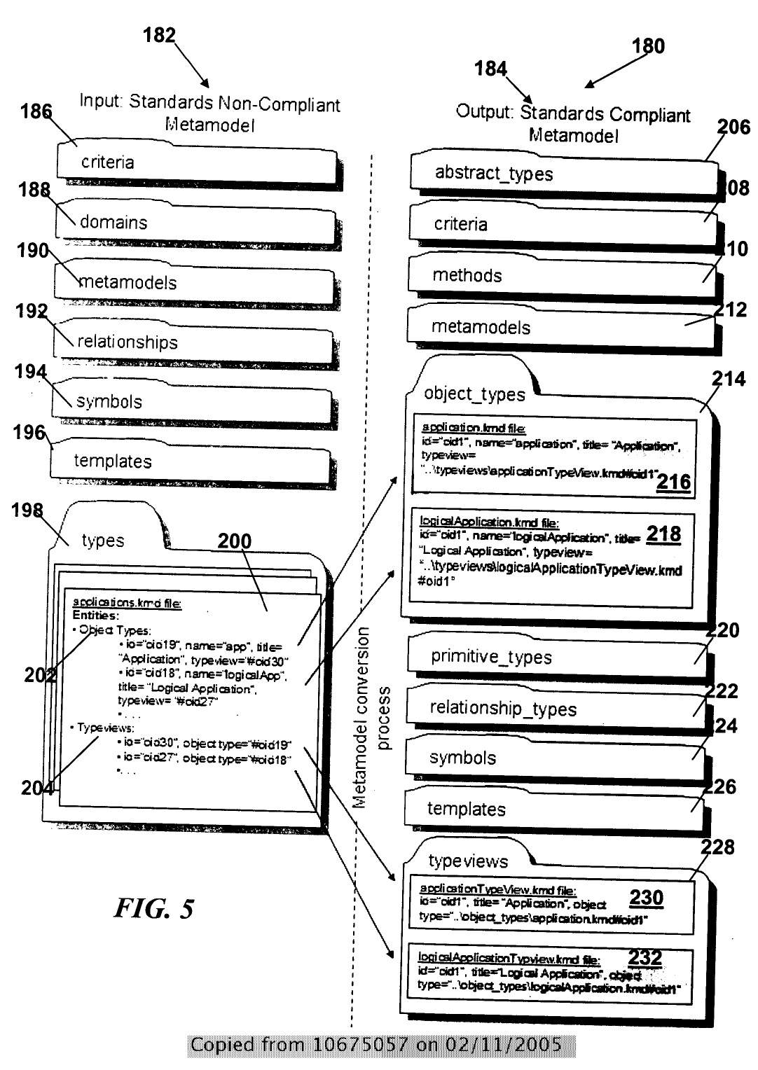

FIG. 5 illustrates one example process 180 of transforming a standards non-compliant metamodel 182 into a standards compliant metamodel 184 according to the teachings of the present invention. Thus, standards non-compliant metamodel 182 may include criteria folder 186, domains folder 188, metamodels folder, 190, relationships folder 192, symbols folder 194, templates folder 196, and types folder 198. Moreover, each such folder may include files, such as applications.kmd file 200, which file contains a number of entities. Such entities may be, for example, object types 202 and typeviews 204.

The metamodel file transformation process 180 of the present invention outputs standards compliant metamodel 184, which includes standards compliant folders and files. Such standards compliant folders may include, for example, abstract_types folder 206, criteria folder 208, methods folder 210, metamodels folder 212, and object_types folder 214. Moreover, object_types folder 214 may include standards compliant files, such as application.kmd file 216 and logicalApplication.kmd file 218. Other standards compliant folders within standards compliant metamodel 184 may include primitive_types folder 220, relationship_types folder 222, symbols folder 226, templates folder 228, and typeviews folder 228. Still further, standards compliant typeviews folder 228 may include standards compliant files such as applicationTypeView.kmd file 230 and logicalApplication-Typeview.kmd file 232. Note that the transformation process 180 of FIG. 5 shows only part of the conversion process for one input file. The present invention, on the other hand, are implemented in XML, which is not shown here for purposes of readability.

The present invention makes possible the use of software programs, particularly metamodel software programs that, due to their being standards-noncompliant, cannot be practically used in a standards-compliant environment such as a standards-compliant enterprise architecture modeling environment. By enabling the reuse of a logical model encoded in a standards-noncompliant metamodel system, the present invention makes an otherwise unusable program potentially highly valuable in a standardized environment. The automated, repeatable process of the present invention provides a series of automated, integrated steps that make possible the conversion of a standards-noncompliant metamodel system into a standards-compliant metamodel system in only a small fraction of the time heretofore required for such a labor-intensive, tedious, and error prone process. Moreover, although the preferred embodiment may employ a series of manual steps, such manual steps may be automated or modified to further increase the speed at which the conversion process may occur.

In summary, the present invention provides a method and system for automatically converting standards-noncompliant metamodel systems into standards-compliant metamodel systems. The invention substitutes automatically standards-noncompliant hyperlinks in the first metamodel system with standards-compliant hyperlinks. Substituting automatically standards-noncompliant entity names associated with entities standards-compliant entity names also occurs. The invention further substitutes automatically standards-noncompliant file names for associated files with standards-compliant file names for said associated files. Organizing entities having standards-compliant entity names into files having standards-compliant file names occurs within the process of the invention. The invention converts object identity values associated with object types into a single predetermined object identity value. Moreover, substituting standards-noncompliant relationship types with standards-compliant relationships types and remaining standards-compliant mark-up language with standards-compliant mark-up language yields the standards-compliant metamodel system.

It is to be understood that the embodiments of the invention herein described are merely illustrative of the application of the principles of the invention. The process could be modified in several ways. First of all, the invention could be modified by using Microsoft® XML Parser® instead of VBA Macros® to parse the metamodel system files. Secondly, the process could use a database instead of a Microsoft Excel® spreadsheet to build the indices used in the conversion process of flowchart 140.

Furthermore, although the present embodiment employs one or more versions of the Metis® metamodeling system, those metamodeling systems made by CaseWise®, Popkin®, and Slate® may also employ one or more embodiment of the present invention. Moreover, the preferred embodiment may be modified or changed by using Visual Basic.Net® instead of Excel® formulas and VBA® macros. In addition, the approach used for Metis® could be extended to other modeling systems and tools, such as Visio®, Popkin®, CaseWise®, or Slate®. Reference herein to details of the illustrated embodiments, therefore, is not intended to limit the scope of the claims, which themselves recite those features regarded as essential to the invention.

1. A method for converting a first metamodel system that is standards-noncompliant into a second metamodel system that is standards-compliant, comprising the steps of:
substituting automatically a plurality of standards-noncompliant hyperlinks within said first metamodel system with a plurality of standards-compliant hyperlinks;
substituting automatically a plurality of standards-noncompliant entity names associated with entities of said first metamodel system with standards-compliant entity names;
substituting automatically a plurality of standards-noncompliant file names for associated files within said first metamodel system with a plurality of standards-compliant file names for said associated files;
organizing said entities having standards-compliant entity names into a plurality of files and folders having standards-compliant file names;
converting object identity values associated with objects within said first metamodel system into a single predetermined object identity value;
substituting standards-noncompliant relationship types within said first metamodel system with standards-compliant relationships types; and
substituting remaining standards-compliant mark-up language within said first metamodel system with standards-compliant mark-up language to yield said second metamodel system.

2. The method of claim 1, further comprising the step of parsing automatically said files within said first metamodal system for said standards-noncompliant entity names.

3. The method of claim 1, further comprising the step of associating said standards non-compliant entity names with said standards-compliant entity names in an index.

4. The method of claim 1, further comprising the step of associating said standards non-compliant file names with said standards-compliant file names in an index.

5. The method of claim 1, further comprising the step of associating said standards non-compliant entity names with said standards-compliant entity names in an index.

6. The method of claim 1, wherein said standards-compliant hyperlinks substituting step further comprises the step of substituting automatically a plurality of standards-noncompliant hyperlinks within said first metamodel system with a plurality of standards-compliant hyperlinks using an index.

7. The method of claim 1, wherein said converting step further comprises the step of setting object identity values associated with objects within said first metamodel system into a single predetermined object identity value of 1.

8. The method of claim 1, further comprising the step of deriving said standards-compliant relationship type names using relationship type connection rules associated with a predetermined set of relationship type derivation rules.

9. The method of claim 1, further comprising the step of verifying the operability of said second metamodel system with an associated model by testing the operation of said standards-compliant hyperlinks in said second metamodel system with said associated model.

10. A method for converting a first metamodel system that is standards-noncompliant into a second metamodel system that is standards-compliant, comprising:
instructions for substituting automatically a plurality of standards-noncompliant hyperlinks within said first metamodel system with a plurality of standards-compliant hyperlinks;
instructions for substituting automatically a plurality of standards-noncompliant entity names associated with entities of said first metamodel system with standards-compliant entity names;
instructions for substituting automatically a plurality of standards-noncompliant file names for associated files within said first metamodel system with a plurality of standards-compliant file names for said associated files;
instructions for organizing said entities having standards-compliant entity names into a plurality of files having standards-compliant file names and storing said entities in a standards-compliant folder structure;
instructions for converting object identity values associated with objects within said first metamodel system into a single predetermined object identity value;
instructions for substituting standards-noncompliant relationship types within said first metamodel system with standards-compliant relationships types; and
instructions for substituting remaining standards-compliant mark-up language within said first metamodel system with standards-compliant mark-up language to yield said second metamodel system.

11. The system of claim 10, further comprising the step of parsing automatically said files within said first metamodal system for identifying said standards-noncompliant entity names.

12. The system of claim 10, further comprising instructions for associating said standards non-compliant entity names with said standards-compliant entity names in an index.

13. The system of claim 10, further comprising instructions for associating said standards non-compliant file names with said standards-compliant file names in an index.

14. The system of claim 10, further comprising instructions for associating said standards non-compliant entity names with said standards-compliant entity names in an index.

15. The system of claim 10, wherein said standards-compliant hyperlinks substituting instructions further comprise instructions for substituting automatically a plurality of standards-noncompliant hyperlinks within said first metamodel system with a plurality of standards-compliant hyperlinks using an index.

16. The system of claim 10, wherein said converting instructions further comprise instructions for setting object identity values associated with objects within said first metamodel system into a single predetermined object identity value of 1.

17. The system of claim 10, further comprising instructions for deriving said standards-compliant relationship types using relationship rules associated with a predetermined set of standardized relationship derivation rules.

18. The system of claim 10, further comprising instructions for verifying the operability of said second metamodel system with an associated model by testing the operation of said standards-compliant hyperlinks in said second metamodel system relative to said model.

19. A storage medium for storing instructions for a system, said system for converting a first metamodel system that is standards-noncompliant into a second metamodel system that is standards-compliant and comprising:
instructions for substituting automatically a plurality of standards-noncompliant hyperlinks within said first metamodel system with a plurality of standards-compliant hyperlinks;
instructions for substituting automatically a plurality of standards-noncompliant entity names associated with entities of said first metamodel system with standards-compliant entity names;
instructions for substituting automatically a plurality of standards-noncompliant file names for associated files within said first metamodel system with a plurality of standards-compliant file names for said associated files;
instructions for organizing said entities having standards-compliant entity names into a plurality of files having standards-compliant file names;
instructions for converting object identity values associated with objects within said first metamodel system into a single predetermined object identity value;
instructions for substituting standards-noncompliant relationship types within said first metamodel system with standards-compliant relationships types; and
instructions for substituting remaining standards-compliant mark-up language within said first metamodel system with standards-compliant mark-up language to yield said second metamodel system.

20. The storage medium of claim 19, further comprising instructions for deriving said standards-compliant relationship types using relationship rules associated with a predetermined set of standardized relationship derivation rules.
